(19) United States
(12) Patent Application Publication
(10) Pub. No.: US 2019/0062211 A1
(43) Pub. Date: Feb. 28, 2019

(54) CEMENTITIOUS INORGANIC MATERIAL CONTAINING CELLULOSIC NANOFIBERS

(71) Applicant: The Governors of the University of Alberta, Edmonton (CA)

(72) Inventors: Vivek Bindiganavile, Edmonton (CA); Mehmet Yaman Boluk, Edmonton (CA); Mounir El-Bakkari, Edmonton (CA); Jose Goncalves, Edmonton (CA)

(21) Appl. No.: 16/111,765

(22) Filed: Aug. 24, 2018

Related U.S. Application Data
(60) Provisional application No. 62/550,100, filed on Aug. 25, 2017.

(51) Int. Cl. C04B 18/24; C04B 28/04; C04B 14/06; C04B 40/00

(52) U.S. Cl. CPC C04B 18/24; C04B 28/04; C04B 2111/2015; C04B 40/0028; C04B 14/06

(57) ABSTRACT

A cementitious inorganic material having improved durability and strength is provided. The cementitious inorganic material includes an inorganic cured matrix, a plurality of cellulosic nanofibers embedded in the inorganic cured matrix, an agent for dispersing the cellulosic nanofibers in the inorganic cured matrix, and an aggregate dispersed throughout the inorganic cured matrix. The inventive cementitious inorganic material provides improved resistance to sulphate attack, chloride attack, vegetation growth, and consequent damage such as expansive cracking, thereby enhancing the durability of cement. A process of making the cementitious inorganic material includes blending the cellulosic nanofibers with water until a homogenous solution is achieved, mixing the dispersing agent with the homogenous mixture, mixing the inorganic matrix material with the homogenous solution, mixing in the aggregate, and allowing the mixture to cure.

### CROSS-REFERENCE TO RELATED APPLICATION

This application claims priority of U.S. Provisional Patent Application Ser. No. 62/550,100 filed Aug. 25, 2017, which is incorporated herein by reference.

### TECHNICAL FIELD

The present invention generally relates to a cementitious inorganic material having improved durability and strength, and more specifically to a cementitious inorganic material containing cellulosic nanofibers that provide, among other things, improved resistance to sulphate attack, chloride attack, vegetation growth, and consequent damage such as expansive cracking.

### BACKGROUND

The Earth Summit (1) and Kyoto Protocols have committed nations to socially, environmentally, and economically sustainable development. The construction industry is responsible for up to 60% of natural resources consumed, as it converts them to building materials (2,3). Concrete is the most consumed man-made building material today with an estimated 0.7-1.0 ton per capita produced yearly (4). At the same time, deleterious interaction with external agents, whether physical or chemical, significantly reduces its lifespan, forcing higher cost upon society in both economic and environmental terms. Among them, sulphate attack, which could arise either from internal or from external sources of sulphates remains a concern for Portland cement systems. Soluble sulphates present in groundwater or soils or even internally in the aggregates react chemically with some components in the microstructure of the Portland cement paste generating expansion and deteriorating the concrete. The loss in durability is strongly dependent on the binder composition, water-to-binder ratio and ambient temperature (5). Popular remedies include the use of specialized Portland cements (Types MS and HS in Canada), adding mineral admixtures, suitable reduction in permeability and imparting crack resistance.

The advent of nanomaterials promises a new range of tailored products that can intervene strategically in the cementitious system through a combination of physical and chemical characteristics. Recently, Ghosal et al. (6) offered a list of emerging products, available commercially to improve cement-based systems. Others (7,8) believe that the application of nanotechnology in cement and concrete remains limited on a commercial level. Nanotechnology has improved our understanding of hydration products (9) and the mechanisms that underlie durability issues in concrete (7,10). While their use was heralded over a decade ago (11), this effort remains confined to nanometallic oxides, nanoclays, nanosilica (8,12-15), carbon nanotubes, carbon nanofibers (10,15-19) or calcareous nanomaterials (7,17,20). The goals have largely been an enhancement to strength, durability and sustainability of cementitious products. These benefits rely on their high surface area-to-volume ratio, resulting in high chemical reactivity or even as seeding agents (7). In case of nanoscale reinforcement (carbon nanotube or nanofibers), one relies on their exceptional tensile strength and elastic modulus, or their electrical properties. However, these aforementioned nanomaterials retain certain limitations for utility in cement based systems, especially: their relative cost, hydrophobic nature, chemical inflexibility and toxicity.

In response, cellulose, the most abundant biopolymer as it is sourced from wood biomass (21-23), offers an attractive alternative. Note that polysaccharides have long been used in cement based systems as rheology modifiers, viscosity enhancers or reinforcing agents. Indeed, the coarser cellulose microfibers (see prior art FIG. 1 adapted from Zhu et al. (24)) have proven themselves in controlling shrinkage or curling (25), impact resistance, shotcrete pumpability and chloride diffusion (26). On the other hand, cellulose nanofibers (CNF) and cellulose nanocrystals are much finer, extracted as they are from the cellulose microfibers present in wood pulps (27). These naturally synthesized nanofibers form the cellulose fiber in plant-cell walls and are strongly linked to each other by numerous inter-fibrillar hydrogen bonds (22). As described in detail elsewhere, a combination of chemical and mechanical processes is employed to achieve nano-defibrillation (21,22). At the end of these treatments, the resulting cellulose nanofiber is about 5-50 nm wide, and 1-5 μm long, with ≈70% crystallinity, possessing electrostatic charge and an extremely high surface area (22,23,28-30). These features favour CNF with uniform dispersion, a high chemical tunability, exceptional hydrophilicity, colloidal properties, high water absorbency, high surface area, and reinforcing potential (23,31). This suite of attributes confers tremendous promise, uniquely suited for a transformational nano-additive to the cement and concrete industry.

CNF trials in cement based systems are strictly nascent. The limited prior investigation, (23,32,33), illustrates an increase in flexural and compressive strength with CNF addition, likely due to a higher degree of hydration and densification in the cement paste microstructure, but accompanied by a lower workability. The amount added varied from 0.05%-5.0% CNF by cement mass. These prior studies also expressed concerns on the possibility that the lignin, pectin and other soluble sugars present in cellulosic fiber-reinforcement may decay in the highly alkaline environment of cement-based materials and reduce the durability (23). However, as remarked by Marikunte et al. (34), when the morphology represents truly “nano” fibers, its non-cellulosic component is negligible, which leads to a better resistance to alkaline environment. Further, it is surmised that with progressing hydration and a consequent increase in the distance between unhydrated cement particles, the hydroxyl and carboxyl groups on the CNF surface may react with calcium ions and adsorb on cement particles. This could potentially delay the rate of hydration (33,35).

As can be seen, the majority of the rare studies available in the literature have tried to approach the nanocellulose as an alternative fiber-reinforcement to the traditional fibers used to improve the known brittleness of the cement-based materials. However, there remains a need for a cementitious materials having improved durability particularly cementitious materials resistant to physical challenges like shrinkage, biological challenges like vegetation and deleterious chemicals such as sulphates and chlorides.

### SUMMARY OF THE INVENTION

A cementitious inorganic material having improved durability and strength is provided. The cementitious inorganic material includes an inorganic cured matrix, a plurality of cellulosic nanofibers embedded in the inorganic cured matrix, an agent for dispersing the cellulosic nanofibers in the inorganic cured matrix, and an aggregate dispersed throughout the inorganic cured matrix. The cementitious inorganic material provides improved resistance to sulphate attack, chloride attack, vegetation growth, and consequent damage such as expansive cracking, thereby enhancing the durability of cement. A process of making the cementitious inorganic material includes blending the cellulosic nanofibers with water until a homogenous solution is achieved, mixing the dispersing agent with the homogenous mixture, mixing the inorganic matrix material with the homogenous solution, mixing in the aggregate, and allowing the mixture to cure.

### BRIEF DESCRIPTION OF THE DRAWINGS

The present invention is further detailed with respect to the following drawings that are intended to show certain aspects of the present invention, but should not be construed as limit on the practice of the invention, wherein:

FIG. 1 shows the prior art hierarchy of cellulose from source to nanofiber (Adapted from Zhu et al. (24));

FIG. 2A shows cellulose nanofibers (CNF) as visible to the naked-eye;

FIG. 2B shows bundles of CNF under Scanning Electron Microscopy as dark regions;

FIG. 2C shows individually defibrillated CNF under Scanning Electron Microscopy;

FIG. 3 is an X-ray diffractogram showing the extensive amorphous phases for diffraction angles, 2θ, between 5° and 30°;

FIG. 4A shows a step in the homogenization of CNF with the design water before mixing;

FIG. 4B shows the step of mixing the CNF with water during homogenization;

FIG. 4C shows the CNF after being homogenized for one hour in the stirring mixer;

FIG. 5A shows a perspective view of a cylinder with the lateral surface covered by epoxy resin in order to enable the unidirectional penetration of the soluble sulphate ions;

FIG. 5B shows a top view of the cylinder of FIG. 5A;

FIG. 6A shows the extraction of 1 gram samples with a drill bit from four spots at different depths (i.e. 3-15 mm) to evaluate sulphate penetration;

FIG. 6B show measurement of the depth from where the samples were collected of FIG. 6A;

FIGS. 7A to 7F are graphs showing sulphate penetration at varying CNF dosage in mixtures based on Type GU Portland cement;

FIGS. 8A to 8C are graphs showing sulphate penetration at varying CNF dosage in mixtures based on Type HS Portland cement;

FIGS. 8D to 8F are graphs showing sulphate penetration at varying CNF dosage in mixtures based on Type HE Portland cement;

FIGS. 8G to 8I are graphs showing sulphate penetration at varying CNF dosage in mixtures based on Type GUb Portland cement;

FIG. 9 is a graph showing sulphate penetration noted with different CNF amounts at 12-weeks of exposure;

FIGS. 10A to 10D are graphs showing expansion measured over a 12-week exposure, for varying amounts of CNF in mixtures based on Type GU, Type HS, Type HE, and Type GUb Portland cement, respectively;

FIGS. 11A to 11D are graphs showing expansion in sulphate solution over 12 weeks exposure after discounting that in distilled water in mixtures based on Type GU, Type HS, Type HE, and Type GUb Portland cement, respectively;

FIG. 12 is a graph showing expansion noted with different CNF amounts at 12-weeks of exposure; and

FIG. 13 is a graph showing compressive strength at 28 days age compared with that after 12 weeks of exposure to sulphate.

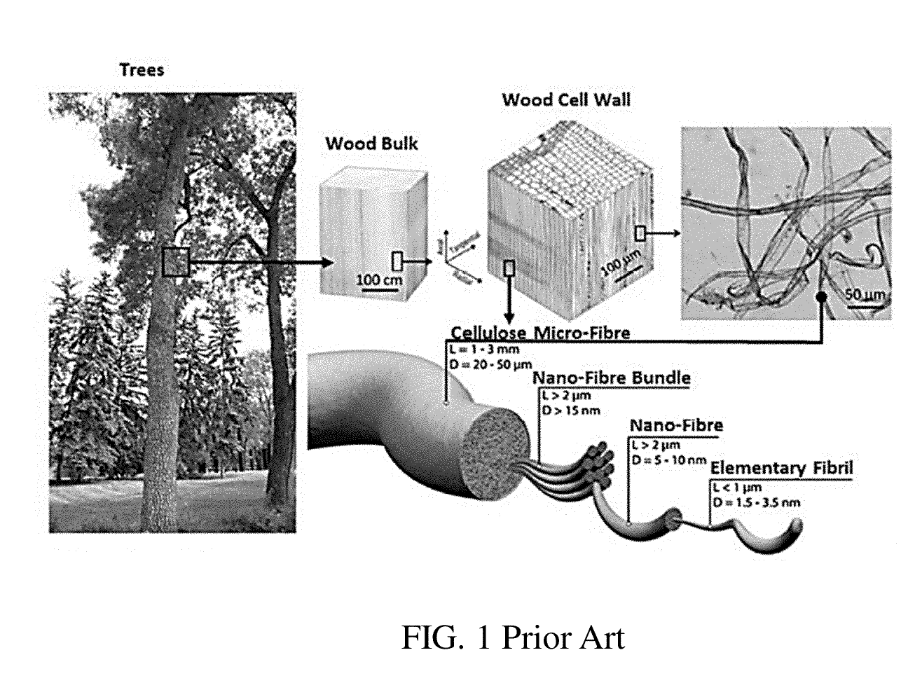

### DETAILED DESCRIPTION OF THE INVENTION

The present invention has utility as a cementitious inorganic material having improved durability and strength, and more specifically as a cementitious inorganic material containing cellulosic nanofibers that provide, among other things, improved resistance to sulphate attack, chloride attack, vegetation growth, and consequent damage such as expansive cracking. CNF's high-water absorbency retains water longer, reducing water loss caused by evaporation and thus reducing cracking due to drying shrinkage at early ages. Additionally, CNF's high hydrophilicity can draw the moisture towards itself and thus decrease the availability of moisture for taking part in the deleterious sulphate reactions, and the oxygen atoms from the numerous hydroxyl and carboxyl groups at the CNF's high surface area that react with the calcium ions sourced from cementitious particles and consequently alleviate the decaying process caused by sulphate attack, chloride attack and other deleterious chemicals. In the process, the present invention extends the lifespan of cementitious materials in an eco-friendly and sustainable manner.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

The present invention utilizes cellulosic nanomaterials including nanocrystals and nanofibers (CNF) to reduce sulphate penetration, chloride induced corrosion of embedded steel, dehydration during internal curing and subsequent dimensional change in cementitious materials. The CNF is used to enhance the durability of cementitious materials by taking advantage of CNF's high-water retention, abundantly exposed —OH and —COON groups, a host of anionic and cationic groups and nanoscale dimension, to function at once, as both a chemical sink and a mechanical reinforcement towards effectively mitigating the adverse effects of these aforementioned physical and chemical adversities.

The present disclosure provides a cementitious inorganic material that includes an inorganic cured matrix, a plurality of cellulosic nanofibers embedded in the inorganic cured matrix, an agent for dispersing the cellulosic nanofibers in and throughout the inorganic cured matrix, and an aggregate dispersed throughout the inorganic cured matrix. According to embodiments of the present disclosure the inorganic cured matrix is either non-hydraulic or hydraulic cement, Portland cement, gypsum, plaster of Paris, lime-based systems, calcium aluminate cement, phosphate cement, alkali-activated materials, geopolymers, mineral admixtures and masonry cements, other calcareous binders, silty-clayey soils, or a combination thereof. As described below, the Portland cement of the cementitious material may be any of a general use Portland cement, a high resistance to sulphate Portland cement, a high early strength Portland cement, or a general use Portland cement combined with various amounts of pozzolanic blends, for instance, 30% mass substitution with fly ash as in the following example. According to embodiments, the aggregate of the cementitious material is sand, quartz sand, rock, gravel, or a combination thereof.

According to various embodiments of the present disclosure, the cellulosic nanofibers are present in an amount that exceeds a percolation threshold of said inorganic cured matrix. As used herein, percolation threshold is defined as the plurality of cellulosic nanofibers being present in an amount such that the nanofibers are randomly connected across the entirety of the matrix. The plurality of cellulosic nanofibers in some inventive embodiments also include retained water.

Embodiments of the present disclosure provide that the plurality of cellulosic nanofibers are cellulose, methylated cellulose, carboxylated cellulose, cellulosic nanocrystals, a combination thereof, or any other suitable material. Further embodiments provide that the plurality of cellulosic nanomaterials including cellulose nanocrystals and cellulose nanofibers are sourced from a plurality of wood-based and natural plant based biomass. In addition, the source may include algae, bacteria, and some sea animals (tunicates). Some examples of natural sources are sisal, flax, hemp, grass, sorghum, barley, sugar cane, sugar beet pulp, pineapple leaf fibers, banana rachis, soy hulls, kenaf stem, swede root, wheat straw, carrots, ramie, empty fruit bunches, palm trees, potato pulp, branch bark of mulberry, bagasse, rice straw, chardonnay grape skins, stems of cacti, coconut husk, bamboo, pea hull fiber, cotton and industrial bioresidues, or a combination thereof.

Embodiment provide that the plurality of cellulosic nanofibers include reactive groups that react with said inorganic matrix as it cures. Moieties operative herein illustratively include cationic group, anionic group, Zwitterion group, C₁-C₄ alkyl , synthetic polymers of 3 to 5,000 repeating units, hydroxyl, C₁-C₄ alkyl ether, carboxyl, C₁-C₄ alkyl ester, thiol, sulfonic acid, sulfinic acid, phosphate, phosphonic acid, nitrate, ammonium, aldehyde, ester, azide, nitro, amide, imine, imide, nitrile, isocyanate, peptide, primary amino, C₁-C₄ alkyl amino, or combinations thereof covalently bonded to a cellulosic nanofiber. Such moieties in some inventive embodiments interact with the inorganic matrix to change at least one property of rheology, setting, hardening, and strength of the cured matrix.

According to embodiments of the present disclosure, the cellulosic nanofibers are elongated with aspect ratios greater than those of cellulosic nanocrystals. It is provided that at current state-of-the-art, each of the nanofibers has a diameter or width varying from 0.1 to 100 nm. It is further provided by embodiments of the present disclosure that at current state-of-the-art, each of the nanofibers has a length in the range of 0.01 microns to 50 microns.

Accordingly, it has been shown that adding CNF results in a reduction in sulphate penetration with all types of Portland cement and other inorganic matrixes. At the same time, there is a concurrent reduction in expansion observed across all binders. Although adding CNF does not by itself lead to a marked change in compressive strength, it prevents any drop-in strength after exposure to sulphate. Furthermore, in mixtures based on Portland cement Type GU, incorporating CNF led to a performance equal or superior, to that seen for the mixtures with the Type HS (high sulphate resistant) Portland cement.

### EXAMPLES

The present invention is further described with respect to the following non-limiting examples. These examples are intended to illustrate specific formulations according to the present invention and should not be construed as a limitation as to the scope of the present invention.

Here, four different Portland cement based binders and mortar mixtures are prepared to have up to 0.5% CNF by volume fraction. After 28 days of moist curing, the mortar specimens are subjected to accelerated sulphate attack for 12 weeks. Unidirectional penetration of sulphate is determined according to a modified ASTM C114 method. Additionally, the change in length is measured in accordance with ASTM C 1012. The results show that CNF visibly reduces the penetration of sulphate ions inside the mortar. As well, it effects a marked reduction in the associated expansion. Of particular significance to the construction industry, it was seen that at 0.3-0.5% by volume fraction, CNF imparts as much resistance to Type GU Portland cement against sulphate attack, as the specially formulated sulphate resistant cements.

The four series of mortars are prepared with the following different binders (36): (i) Type GU Portland cement (GU); (ii) Type HS Portland cement, known for its high-sulphate resistance (HS); (iii) Type HE Portland cement, known for its high-early strength (HE); and (iv) Type GUb blended Portland cement with 70% Type GU and 30% Fly Ash by weight (GUb). Notably, Type GU Portland cement (and its regional counterparts) is by far the most consumed hydraulic cement globally, but it has high aluminate content which makes it vulnerable to sulphate attack. This is usually countered by Type HS Portland cement (and its regional counterparts), with the lowest aluminate content among the Portland cements. Type HE Portland cement is ground finer and may contain more tricalcium aluminate than the other cement types, which in turn renders it susceptible to sulphate attack. The blended Type GUb while promoting sustainable practice, is intended to render sulphate resistance through lower aluminate availability and calcium hydroxide consumption. To these series, is added in increments of 0.1% up to 0.5% of dry CNF as volume fraction of mortar in Type GU, and up to 0.2% volume fraction in the other 3 series. These mortars are prepared and evaluated for sulphate resistance along 12 weeks according to ASTM C1012 (37). The sulphate penetration is also assessed for the same period of time. The procedure involves the extraction of samples from distinct depths of the mortar specimens exposed to sulphate solution, at different time intervals and, the determination of the sulphate content of these samples through a method similar to ASTM C114 (38).

### Raw Materials and Mixture Proportions

The relevant physical and chemical properties of the CNF used are listed in Table 1.

TABLE 1
Some characteristics of CNF.

| | | Solid | Carboxyl | Water Retention |
|---|---|---|---|---|
| Wet Density | Dry Density | Content | Content | Value |
| (g/cm³) | (g/cm³) | (%) | (mmol/g fibre) | (g/g) |
| 1.0095 | 1.38 | 2.945 | 0.13 | 3.62 |

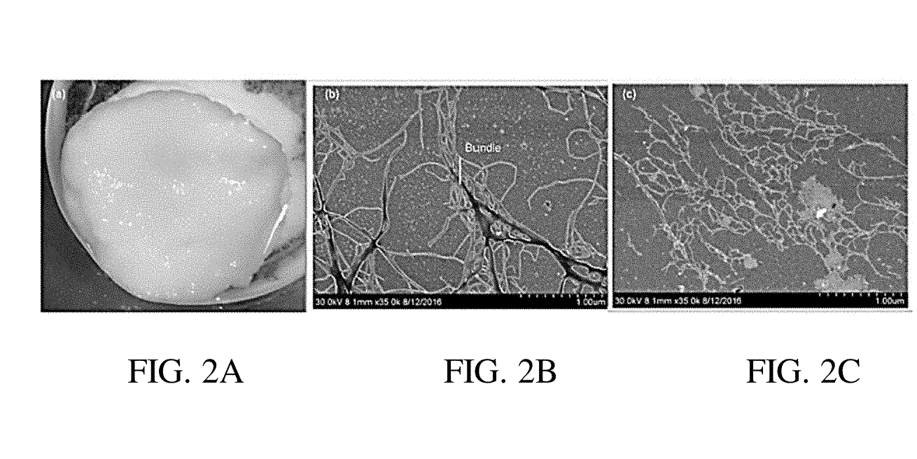

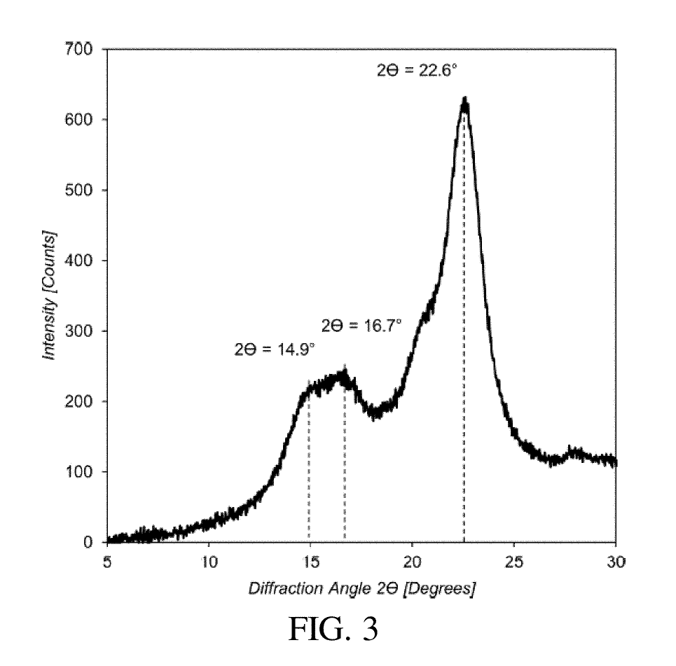

The density is measured using a pycnometer while the solid content is found by drying the sample at 40±1° C. on a hot-plate until such time that a constant mass was recorded. The carboxylate content of this nanofiber is determined using an electric conductivity titration method (39) and the water retention is measured according to Saito et al. (28). Note that the CNF is obtained as a suspension, containing 3% fiber solids and the remaining 97%, water. The scanning electron micrograph (SEM) in FIGS. 2B and 2C reveal a combination of nanofibrils that range from 20 to 50 nm in diameter and up to 2 μm in length. The XRD analysis is measured on vacuum-oven dried and compacted CNF sample by a Bruker D8 Discover device with I μS Cu-Kα radiation and Vantec-500 2-dimensional detector. Data is acquired for 120 sec/frame and is integrated using 2 Theta (2θ) steps of 0.02° and 2θrange from 5° to 112°. FIG. 3 exhibits a typical XRD diffractogram for CNF taken at its chief scattering radiation range, i.e. from 2θin 5° to 30° (40), showing a sharp peak at 2θ=22.6° and overlapping peaks at 14.9° and 16.7°. Based on the pattern, the CNF crystallinity index is evaluated at 68.8% by mass fraction according to XRD peak height method, i.e. the height ratio between the intensity of the crystalline peak and total intensity after subtraction of the background signal measured without cellulose (41).

All four binders are obtained from a local cement supplier. The relevant sulphate and aluminate content are listed in Table 2. A quartz sand, graded per ASTM C33 (42), is used. It has an oven-dry density of 2.634 Mg/m³ and a bulk density of 1.589 Mg/m³, as measured per ASTM C128 (43) and ASTM C29 (44), respectively. A superplasticizer with a density of 1.042 g/cm³ and solid content of 31.5%, is used in all those mixes containing CNF.

TABLE 2
Some characteristics of the hydraulic cements.

| Cement | SO₃^{a} (%) | | | C₃A^{b} (%) | | | |
|---|---|---|---|---|---|---|---|
| Type | Min | Average | Max | Min | Average | Max | f [symbol] ^{c} (MPa) |
| GU | 2.65 | 2.71 | 2.76 | 5.9 | 6.37 | 7 | 43.1 |
| HS | 2.16 | 2.21 | 2.26 | 0.6 | 1.37 | 1.9 | 43.7 |
| HE | 3.19 | 3.26 | 3.33 | 6.2 | 6.89 | 7.6 | 40.8 |
| GUb | 2.59 | 2.66 | 2.72 | — | — | — | 41.3 |

^{a}SO₃ is sulfur trioxide.
^{b}C₃A is tricalcium aluminate.
^{c}f [symbol] is compressive strength at 28 days. [symbol]
indicates data missing or illegible when filed

The mortars are made as described in ASTM C109 (45), with 1-part cement mixed with 2.75 parts of graded standardized quartz sand, by mass. The water-binder ratio is set at 0.485. Noting that the CNF is in a suspension, the water in that suspension is discounted from the mix design, to ensure that the water-binder ratio remains a constant. With the plain Type GU mixture, a flow range of 30±5% is achieved per ASTM C1437 (46). At 97% water content, it is possible to add up to 0.5% (0.489% to be exact) CNF solids by volume fraction, as that results in the entire mix water being sourced from the suspension itself. As already stated, adding CNF reduces the mortar workability, so that the aforementioned superplasticizer is added in order to achieve the desired workability at constant water-to-binder ratio. There is a variation in the amount of superplasticizer required by the Types HS, HE and GUb, for CNF addition beyond 0.2% by volume. Accordingly, only the Type GU is examined with CNF up to 0.5% by volume. Type HS, HE and GUb are prepared with up to 0.2% CNF only, as the amount of superplasticizer required exceeded the limit prescribed by its manufacturer for higher CNF dosage with these binders. The mixture constituents and their proportions are listed in Table 3.

TABLE 3
Mixture composition for mortars examined.

| Cement | Dry CNF | Wet CNF | Water | SP | Cement | Sand | Flow |
|---|---|---|---|---|---|---|---|
| Type | (% V.F.) | (kg/m³) | (kg/m³)^{c} | (kg/m³)^{d} | (kg/m³) | (kg/m³) | (%) |
| GU; HS; HE^{a} | 0 | 0 | 262.6 | 0 | 541.3 | 1488.7 | 26-34^{d} |
| GUb^{b} | 0 | 0 | 258.4 | 0 | 532.8 | 1465.1 | 29 |
| GU; HS; HE^{a} | 0.1 | 50.8 | 213.3 | 6.2-7.9^{d} | 540.3 | 1485.9 | 28-35^{d} |
| GUb^{b} | 0.1 | 50 | 209.6 | 5.5 | 531.8 | 1462.3 | 30 |
| GU; HS; HE^{a} | 0.2 | 101.5 | 164.2 | 12.3-14.0^{d} | 539.3 | 1483.1 | 29-32^{d} |
| GUb^{b} | 0.2 | 99.9 | 160.4 | 11.8 | 530.7 | 1459.5 | 27 |
| GU [symbol] | 0.3 | 151.9 | 94.6 | 28.1 | 538.3 | 1480.3 | 25 |
| | 0.4 | 202.2 | 45.2 | 28.1 | 537.3 | 1477.5 | 5 |
| | 0.5 | 250.2 | −1.9 | 28.1 | 536.2 | 1474.7 | 0 |

^{a}Types GU, HS and HE cement assumed specific gravity equal to 3.15 g/cm³.
^{b}Type GUb cement assumed specific gravity equal to 2.88 g/cm³.
^{c}Mixing water content discounted of the water from wet CNF and superplasticizer (SP).
^{d}Varies in function of the cement type. [symbol]
indicates data missing or illegible when filed

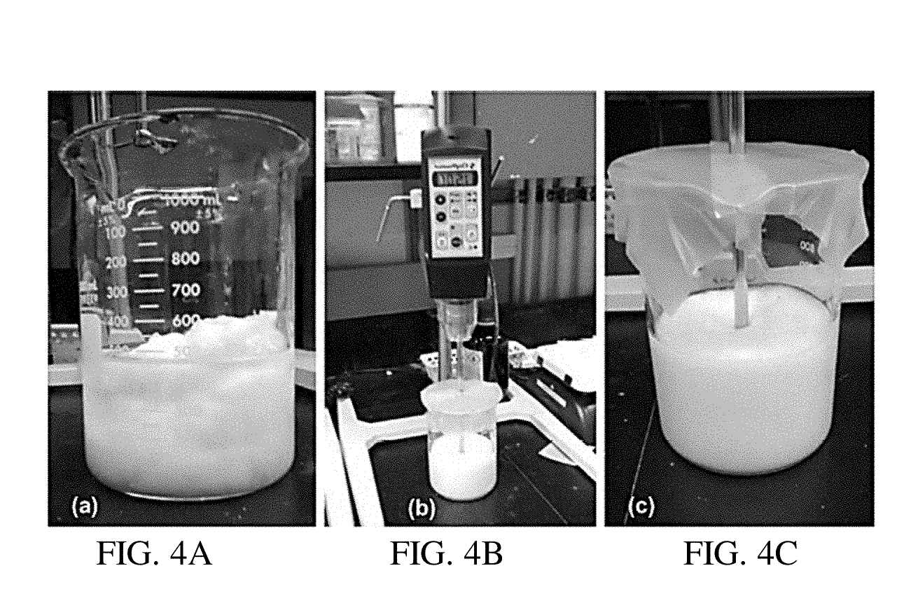

The mixtures are prepared in accordance with ASTM C109 (45). An hour prior to mixing, the CNF suspension and additional mixing water (if required) are pre-homogenized for 60 minutes in a stirring mixer, as shown in FIGS. 4A-4C. Typical stirring occurs at a shear rate of 100 to 10,000 per reciprocal second. In order to achieve a homogenous suspension within 60 minutes, the stirring speed is varied according to CNF addition: (i) 500 rpm for 0.1-0.2% CNF, (ii) 1,000 rpm for 0.3% CNF, and (iii) 1,500 rpm for 0.4% CNF. For mixtures with 0.5% volume fraction of dry CNF, no pre-mixing is required, given that all the water added to the mix is through the CNF suspension itself. The liquid superplasticizer is added to the suspension during the subsequent mixing in a high shear mixer.

### Test Protocols

Each mortar mixture is cast into nine prisms, of dimension 25 mm×25 mm×285 mm. A further eleven cylindrical specimens of diameter 50 mm and 100 mm height are also cast for each mixture. The specimens are demolded the next day and cured for a further 27 days in a controlled environment (23±2° C. and >95% relative humidity) as recommended by ASTM C1012 (37). Six out of nine prisms are submerged in a sodium sulphate solution for 12 weeks at 23±2° C. room temperature, according to ASTM C1012 (37). The pH of the sodium sulphate solution is held at 7.8 before immersion. The remaining three bars are immersed in distilled water at a proportion 4±0.5 volumes of water to 1 volume of mortar bars, i.e., it is maintained at the same proportion of liquid to solid as the prisms submerged in the sulphate solution, which is required by the test guideline. The nine bars are examined at 1 week, 2, 4, 8 and 12 weeks after being placed in their respective liquid bath in compliance with ASTM C1012 (37). Using a length comparator that meets ASTM C₄₉₀ (47), the length change in bars submerged in sulphate solution and that in water is first calculated. Thereafter, the difference between them is taken in order to account for the effect of the external sulphate exposure alone.

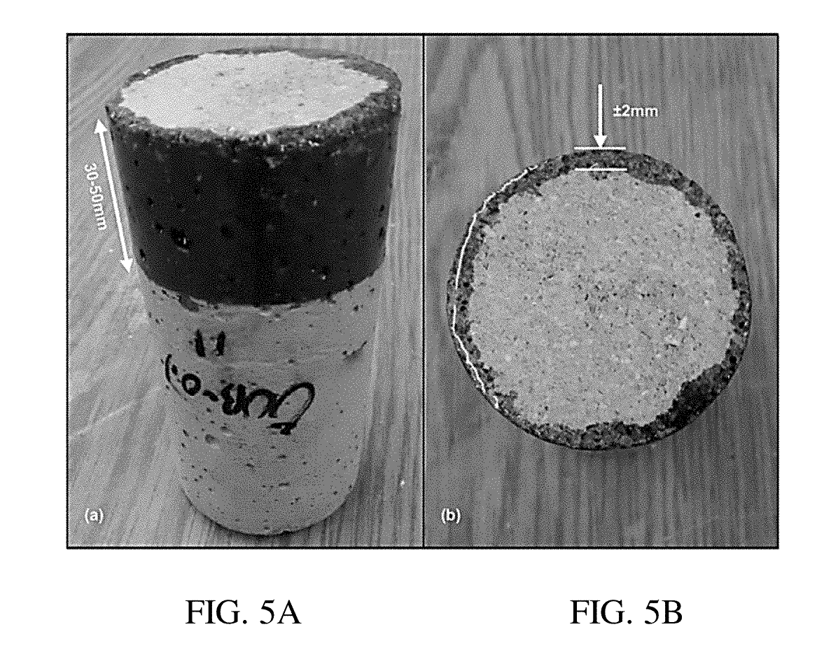

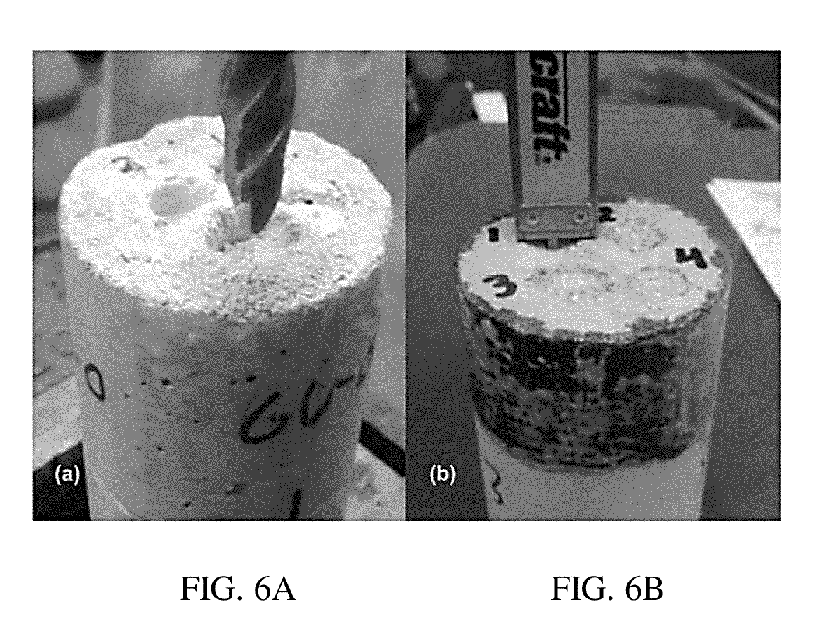

One cylinder is used to determine the reference sulphate content at 28 days (i.e., at zero sulphate exposure). The remaining 10 cylinders are partially covered with an epoxy resin on their lateral surfaces. This is done to ensure that the ionic sulphate penetration is restricted to uni-dimensional penetration, as shown in FIGS. 5A and 5B. Accordingly, five out of ten specimens are submerged in the sodium sulfate solution as per ASTM C1012 (37) and, the other five are immersed in distilled water for 12 weeks. From then on, samples are extracted by drilling from different depths (i.e. varying from 3 to 15 mm) at distinct ages (i.e. at 28 days since cast and after 1 week, 2, 4, 8 and 12 weeks of immersion) and the sulphate content at each depth is determined through chemical analysis. FIGS. 6A and 6B illustrate the procedure adopted. The sulphate content is assessed from the precipitate after treating the sample with barium chloride. In brief, at least 1 gram of ground sample, dried at 105±5° C. for 24 hours, is digested in hydrochloric acid solution for 60 minutes in a procedure similar to ASTM C114 (38). The digested sample is centrifuged at 2,000× g for 15 minutes at indoor temperature. Everything except quartz goes into solution. This solution is now filtered through a medium textured paper. This filtrate is titrated with 10mL of barium chloride, and digested for two hours. The precipitated barium sulphate, is filtered using an air-pump and dried at 105±5° C. for 24 hours. The sulphate content expressed in mg/g is equal to weight of the dried barium sulphate in grams multiplied by the molecular ratio of the sulphate to barium sulphate (i.e. 96/233) and multiplied by 1,000. The sulphate penetration obtained for cylinders prior to sulphate exposure is subtracted from that assessed on cylinders submerged in the sulphate solution. From this value, the sulphate content in specimens submerged for the corresponding duration in distilled water is discounted. The resulting measurement is taken to be the sulphate penetration at that specific depth inside the specimen for a given age.

The hardened mortars are tested per ASTM C109 (45) on specimens at 28 days of curing (i.e. zero sulphate exposure) and again, after 12 weeks of exposure.

### Results and Discussion

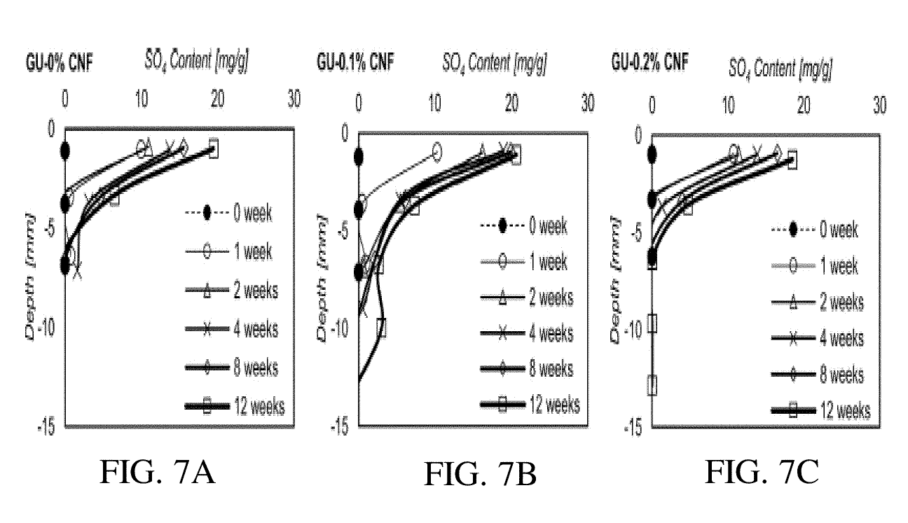

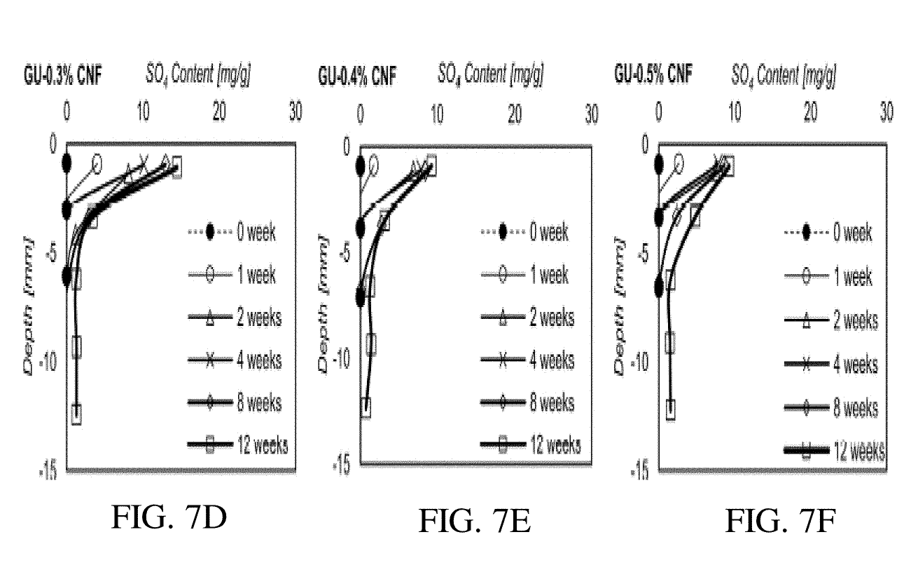

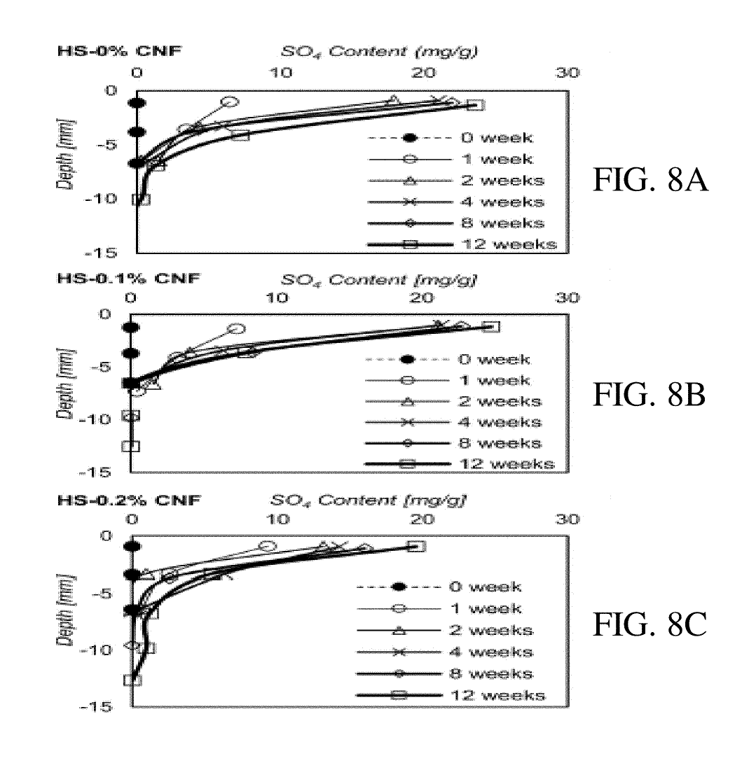

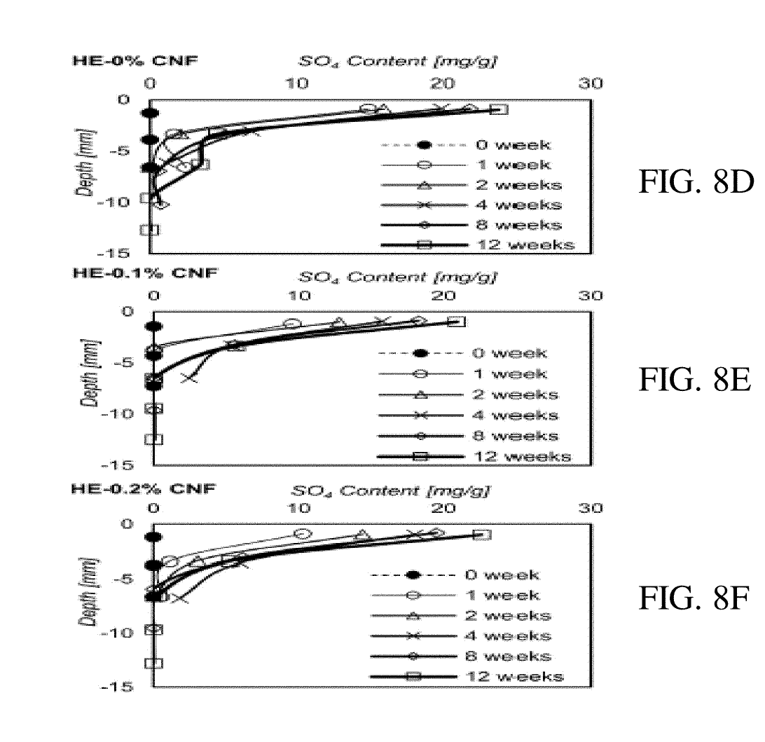

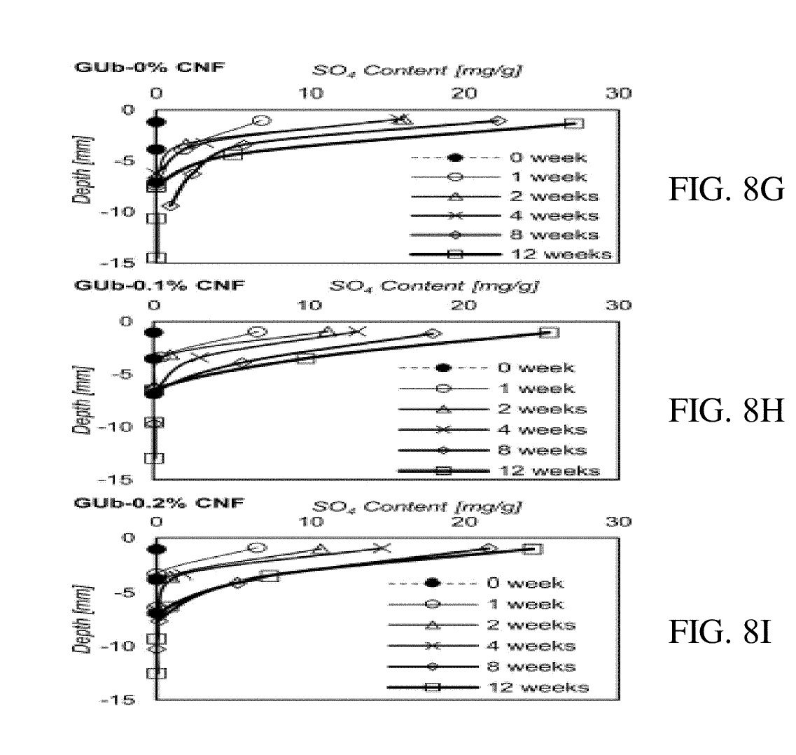

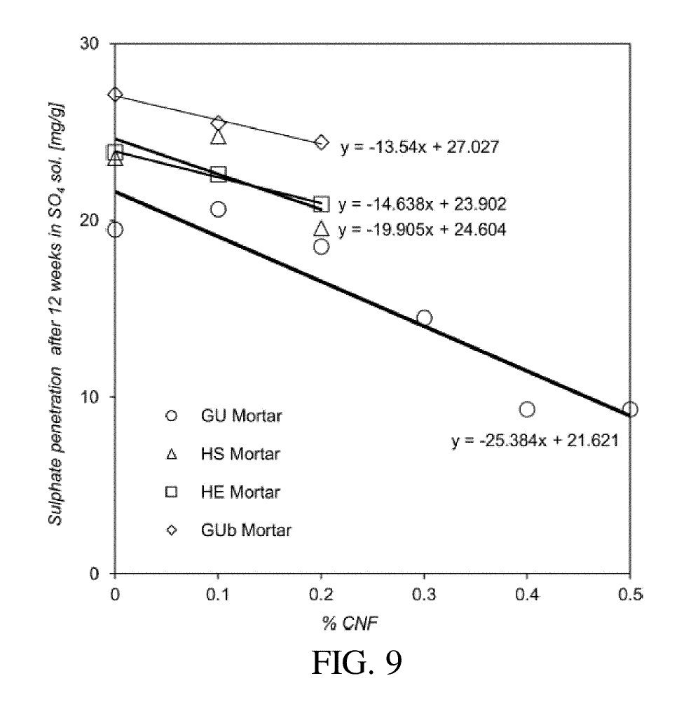

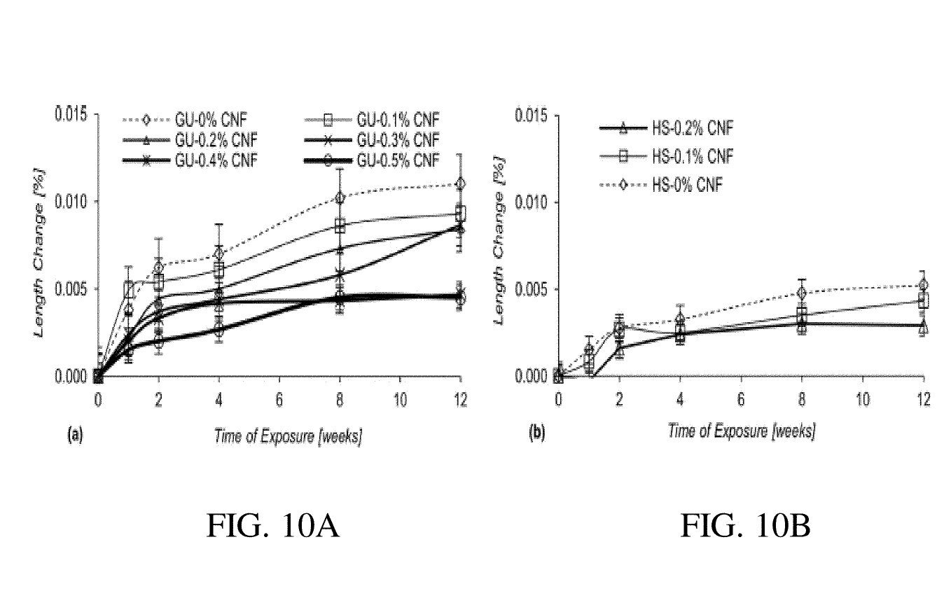

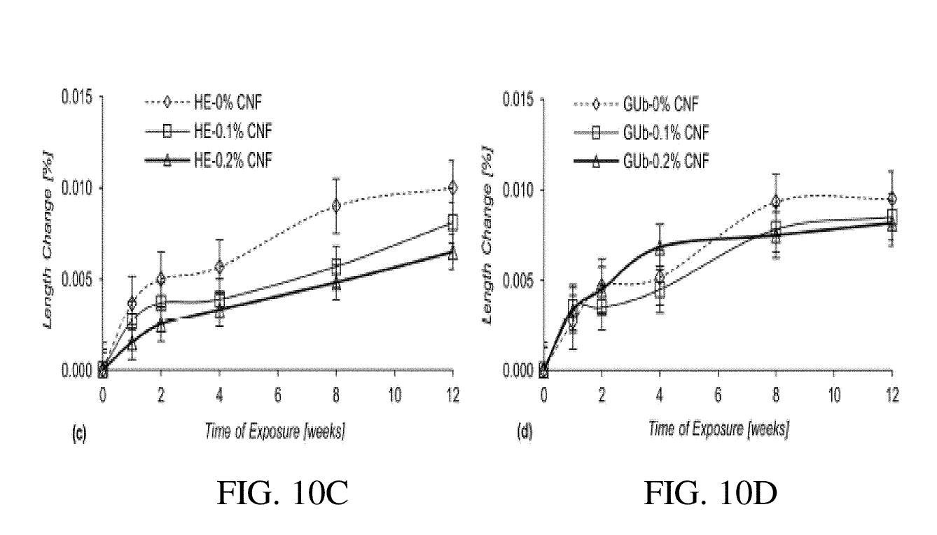

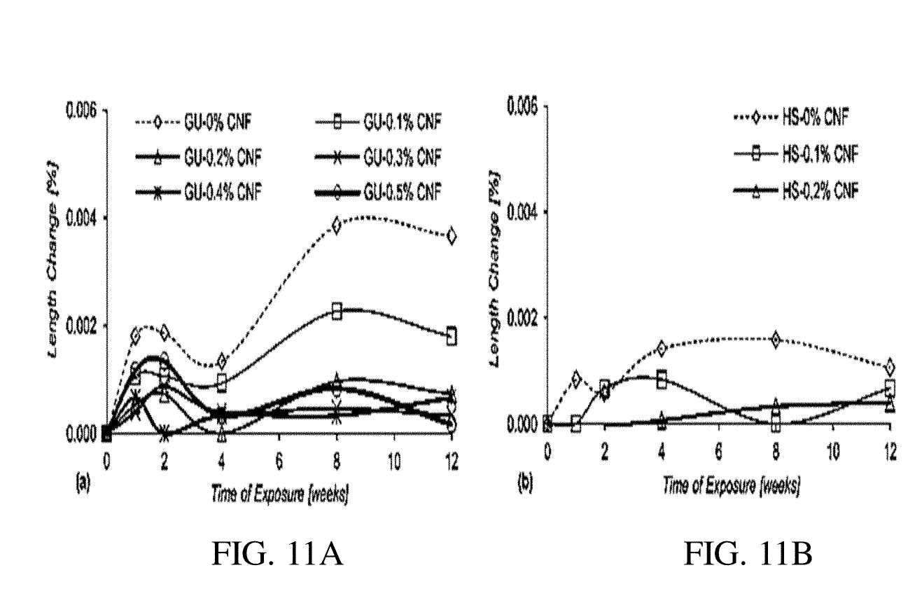

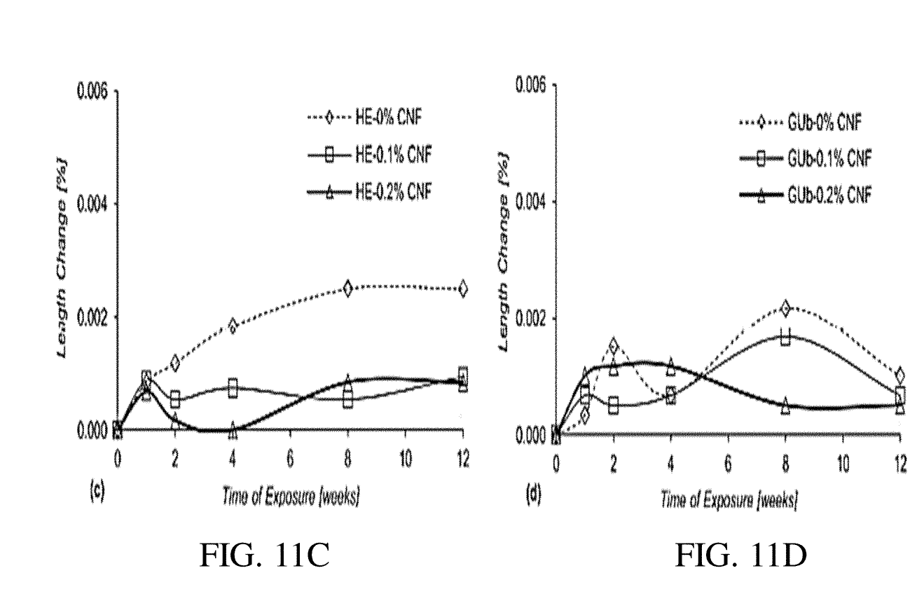

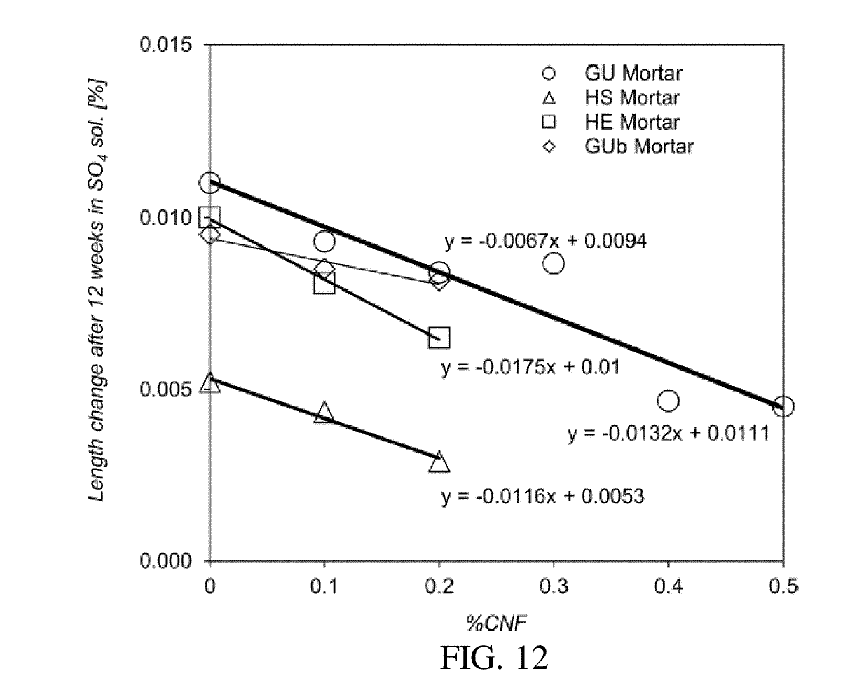

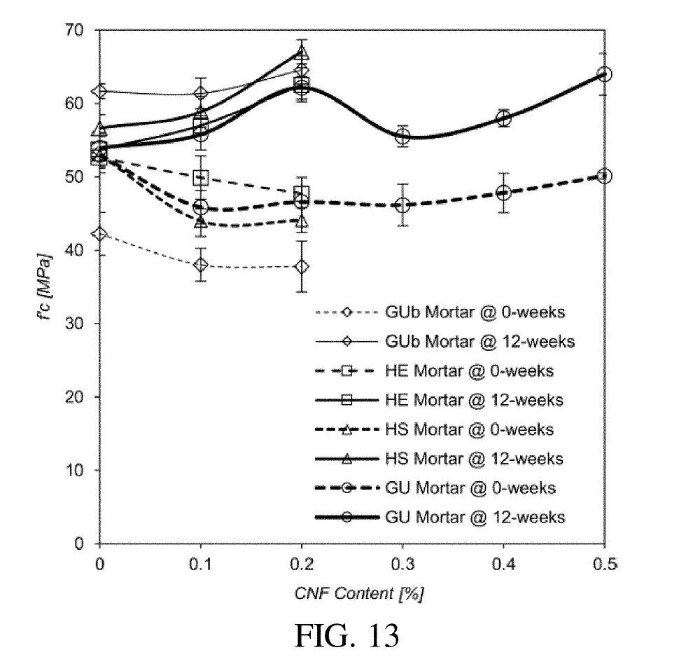

The penetration of sulphate ions into the specimen over the 12 weeks of exposure is mapped as shown in FIGS. 7A-7F for mortars with Type GU cement, in FIGS. 8A-8C for Type HS, in FIGS. 8D-8F for Type HE, and in FIGS. 8G-8I for Type GUb. Again, a comparison across all mixtures after 12 weeks of exposure is illustrated in FIG. 9. The evolution of the expansion caused by sulphate exposure over 12 weeks is shown in FIGS. 10A-10D. FIGS. 11A-11D depict the same sulphate attack but discounted for the expansion in water. FIG. 12 portrays the behaviour of these mixtures merely at 12-week-sulphate-solution exposure. The compressive strength at zero exposure (i.e., at 28 days) and 12 weeks of sulphate exposure are shown in FIG. 13.

### Effect of CNF on Sulphate Penetration

The penetration of sulphate ions into the mortar matrix is evaluated through chemical analyses of samples extracted at depths up to 15 mm. As seen in FIG. 7A to FIG. 9, the sulphate penetration upon adding CNF is only slightly minimized up to 0.2% volume fraction in the mixture. This is true across all binders. However, when the CNF dosage exceeds 0.2%, it is clear that the sulphate penetration is vastly reduced, as evident for the Type GU series in FIGS. 7A-7F. Even at a depth of only 3 mm, the sulphate content is reduced to 50% after 12 weeks of accelerated sulphate attack, FIG. 9. This reduction is likely due to internal curing facilitated by CNF. The hydrophilic nature of CNF due to the presence of hydroxyl (OH) groups is augmented by the introduction of carboxyl (COOH) groups on the surface of CNF (23,48). Due to the nanoscale of this CNF, over 30% of (OH) groups appear on the surface of the cellulose nanofiber, which is much higher than in the cellulose microfiber, used hitherto to mitigate shrinkage and curling. Whereas in conventional cement-based systems, the hydration process in mature ages is characterised by low availability of water, the CNF works like an internal water reservoir. Given their water retention, the nanofibrils gradually liberate the retained water to react with the unhydrated cement particles (23). Consequently, the degree of hydration increases and the porosity of the cement paste diminishes. Together, this renders the material more impervious and water tight. The beneficial effects of CNF addition on pore-size refinement at late ages is better seen in FIG. 13. Increments in CNF content result in a slightly lower compressive strength at 28 days age, i.e. prior to immersion in the sulphate solution. On the other hand, for specimens exposed to sulphate, this effect is reversed. At later ages (i.e. after 12 weeks of exposure), when the availability of water is scarce, the CNF together with its retained water may likely lead to a pore size refinement and so, explain the marginal increase in the compressive strength with the addition of the CNF.

In mature systems, the active radicals on the CNF surface can react with certain available cations, such as calcium (23). Calcium and water are crucial inputs for sulphate attack. Without them, the internally unstable monosulphoaluminate (i.e. AFm) does not convert into the expansive ettringite (i.e. AFt). And, the external source of sulphate inside this mixture does not have available gypsum (i.e. calcium sulphate hydrate) to form expansive ettringite, given that the Portlandite formation is slowed and diminishes the gypsum formation (5). In addition, due to the hydrophilic nature of (COOH) groups or indeed the cellulose itself, the pore water is trapped on the surface of CNF, adding to the water reservoir around the CNF. This captures the (SO4)²⁻ ions and likely reduces their further diffusion. In sum, through a combination of physical and chemical mechanisms, CNF is seen to passivate sulphate attack inside the cement based system.

### Effect of CNF on Length Change

Since the presence of sulphate ions in the matrix does not by itself imply adverse response under sulphate attack, the length change at various stages of sulphate exposure is examined. Adding CNF to the mixtures uniformly reduce the expansion caused by sulphate attack, as seen in FIGS. 10A-10D and 11A-11D. It was true for all the binders examined. FIG. 12 shows a decrease in length, linearly proportionate to the CNF content. The performance of the Type HS binder with no CNF added is taken as the benchmark to be met. The effect of CNF on the sulphate resistance of various binders is best seen in FIGS. 11A-11D, wherein the expansion in water is discounted from the total length change. Also, the performance of the unreinforced Type HS mixture was projected onto those of the other mixtures. Accordingly, it is clear that adding CNF brought the Type GU, Type HE and Type GUb mortars closer in sulphate resistance to the benchmark set by the plain Type HS mixture. At CNF volume fractions at and beyond 0.3%, Type GU mortar depicts lower length change than the benchmark. This is most encouraging as it shows that an alternative to Type HS is possible through adding CNF to Type GU binders.

FIG. 12 allows for a comparison across various binders. Notably, both Type HE and Type GUb are comparable to each other in performance. The proportional decrease in length change with an increase in the CNF dosage suggests a sustainable alternative to Type HS through CNF addition on Type GUb binders.

It is well-known that fibers provide a bridging effect in transferring stresses across the micro-cracks and enhance the dimensional stability of concrete (49-53). Note that the CNF employed here is 20-50 nm thick with an aspect ratio between 40 and 100. This makes the CNF finer and more slender than conventional cellulosic microfibers. As mentioned earlier, the mechanical properties of CNF are superior by far, compared with conventional cellulose microfibers or synthetic macro and microfibers. (21,54). Bhalerao et al. (55) attests to CNF imparting superior fracture resistance to concrete. Peters et al. (56) demonstrated an enhanced fracture energy in concrete due to CNF addition. Thus, the mitigation in length change as seen here with CNF, is due to a combination of reduced sulphate availability in the matrix as well as crack bridging offered by the nanofiber.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

### CITED REFERENCES

(1) United Nations (UN). The Rio Earth Summit: The United Nations Conference on Environment and Development. Rio de Janeiro. Brazil. http://www.un.org/geninfo/bp/intro.html, 1992 (accessed 17.05.2017).

(2) J. Kline, L. Barcelo, Cement and CO2, a victim of success. Cement Industry Technical Conference, 2012 IEEE-IAS/PCA 53rd (2012) 1-14.

(3) C. J. Kibert, Establishing principles and a model for sustainable construction. Proceedings of the First International Conference of CIB Task Group 16 on Sustainable Construction (1994) 3-12.

(4) M. Sonebi, Y. Ammar, P. Diederich, Sustainability of cement, concrete and cement replacement materials in construction, in: J. M. Khatib (Eds.), Sustainability of Construction Materials (2nd edition), Woodhead Pub. Series in Civil and Structural Eng., Duxford, UK, 2016, pp. 371-396.

(5) J. Marchand, I. Odler, J. Skalny, Sulphate Attack on Concrete, Spon Press, London, UK, 2002.

(6) M. Ghosal, A. K. Chakraborty, Application of nanomaterials on cement mortar and concrete: A study, IUP Journal of Structural Engineering, 10.1 (2017) 7-15.

(7) F. Sanchez, K. Sobolev, Nanotechnology in concrete—a review, Construction and Building Materials, 24.11 (2010) 2060-2071.

(8) K. Sobolev, I. Flores, R. Hermosillo, L. M. Torres-Martinez, Nanomaterials and nanotechnology for high-performance cement composites, in: K. Sobolev, S. P. Shah (Eds.), Nanotechnology of Concrete: Recent Developments and Future Perspectives SP 254, American Concrete Institute, Farmington Hills, USA, 2008 pp. 91-120.

(9) P. Mondal, Nanomechanical properties of cementitious materials. PhD Thesis, Northwestern University, Illinois, USA; 2008.

(10) F. Pacheco-Torgal, S. Jalali, Nanotechnology: advantages and drawbacks in the field of construction and building materials, Construction and Building Materials 25.2 (2011) 582-590.

(11) W. Zhu, P. Bartos, A. Porro, Application of nanotechnology in construction: Summary of a state-of-the-art report, Materials and Structure, 37.9 (2004) 649-658.

(12) A. Porro, J. S. Dolado, I. Campillo, E. Erkizia, Y. De Miguel, Y.S. De Ibarra, A. Ayuela, Effects of nanosilica additions on cement pastes, in: Applications of nanotechnology in concrete design, Thomas Telford Publishing, Dundee, UK, 2005, pp. 87-96.

(13) A. Ghosh, V. Sairam, B. Bhattacharjee, Effect of nano-silica on strength and microstructure of cement silica fume paste, mortar and concrete, Indian Concrete Journal 14.1 (2013) 11-25.

(14) G. Quercia, P. Spiesz, G. Hiisken, H. J. H. Brouwers, SCC modification by use of amorphous nano-silica, Cement and Concrete Composite 45 (2014) 69-81.

(15) M. Sonebi, E. Garcia-Taengua, K. M. A. Hossain, J. Khatib, M. Lachemi, Effect of nanosilica addition on the fresh properties and shrinkage of mortars with fly ash and superplasticizer, Constr. Build. Mater. 84 (2015) 269-276.

(16) S. Kumar, P. Kolay, S. Malla, S. Mishra, Effect of multiwalled carbon nanotubes on mechanical strength of cement paste, Journal of Materials in Civil Engineering, 24.1 (2012) 84-91.

(17) A. Lazaro, Q.L. Yu, H. J. H. Brouwers, Nanotechnologies for a sustainable construction, in: J. M. Khatib (Eds.), Sustainability of Construction Materials (2nd edition), Woodhead Pub. Series in Civil and Structural Eng., Duxford, UK, 2016, pp. 55-78.

(18) M. Gdoutos-Konsta, Z. Me taxa, S. Shah, Highly dispersed carbon nanotube reinforced cement based materials, Cement and Concrete Research 40 (2010) 1052-1059.

(19) R. Nadiv, M. Shtein, A. Peled, O. Regev, Cement reinforcement by nanotubes, in: K. Sobolev, S. Shah (Eds), Nanotechnology in Construction, Springer International Publishing, Cham, CH 2015, pp. 231-237.

(20) Z. Wu, C. Shi, K. H. Khayat, S. Wan, Effects of different nanomaterials on hardening and performance of ultra-high strength concrete (UHSC), Cement and Concrete Composites 70 (2016) 24-34.

(21) S. J. Eichhorn, A. Dufresne, M. Aranguren, N. E. Marcovich, J. R. Capadona, S. J. Rowan, W. Gindl, Review: Current international research into cellulose nanofibers and nanocomposites, Journal of Materials Science 45 (2010) 1-33.

(22) A. Isogai, T. Saito, H. Fukuzumi, TEMPO-oxidized cellulose nanofibers, Nanoscale, 3.1 (2011) 71-85.

(23) L. Jiao, M. Su, L. Chen, Y. Wang, H. Zhu, H. Dai, Natural Cellulose Nanofibers As Sustainable Enhancers in Construction Cement, PLoS ONE 11.12 (2016) 1-13.

(24) H. Zhu, Z. Jia, Y. Chen, N. Weadock, J. Wan, O. Vaaland, L. Hu, Tin anode for sodium-ion batteries using natural wood fiber as a mechanical buffer and electrolyte reservoir, Nano letters 13.7 (2013) 3093-3100.

(25) N. Banthia, V. Bindiganavile, F. Azaria, C. Zanotti, Curling control in concrete slabs using fiber reinforcement, Journal of Testing and Evaluation 42.2 (2014) 1-8.

(26) N. Banthia, V. Bindiganavile, J. Jones, J. Novak, Fiber-reinforced concrete in precast concrete applications: Research leads to innovative products, PCI journal 57.3 (2012) 33-46.

(27) D. Klemm, F. Kramer, S. Moritz, T. Lindstrom, M. Ankerfors, D. Gray, A. Dorris, Nanocelluloses: A new family of nature-based materials, Angewandte Chemie International Edition, 50.24 (2011) 5438-5466.

(28) T. Saito, S. Kimura, Y. Nishiyama, A. Isogai, Cellulose nanofibers prepared by TEMPO-mediated oxidation of native cellulose, Biomacromolecules 8.8 (2007) 2485-2491.

(29) S. Fujisawa, Y. Okita, H. Fukuzumi, T. Saito, A. Isogai, Preparation and characterization of TEMPO-oxidized cellulose nanofibril films with free carboxyl groups, Carbohydrate Polymers 84.1 (2011) 579-583.

(30) Y. Gao, The Production and Characterization of Cellulose Nanofibrils. Thesis M.Sc., University of Alberta, Edmonton, Calif., 2013.

(31) A. Pei, N. Butchosa, L. A. Berglund, Q. Zhou, Surface quaternized cellulose nanofibrils with high water absorbency and adsorption capacity for anionic dyes, Soft Matter 9.6 (2013) 2047-2055.

(32) S. Peters, T. Rushing, E. Landis, T. Cummins, Nanocellulose and microcellulose fibers for concrete, Journal of the Transportation Research Board 2142 (2010) 25-28.

(33) C. G. Hoyos, E. Cristia, A. Vazquez, Effect of cellulose microcrystalline particles on properties of cement based composites, Materials & Design 51 (2013) 810-818.

(34) S. Marikunte, P. Soroushian, Statistical evaluation of long-term durability characteristics of cellulose fiber reinforced cement composites, ACI Materials Journal 91.6 (1994) 607-616.

(35) T. Poinot, M. C. Bartholin, A. Govin, P. Grosseau, Influence of the polysaccharide addition method on the properties of fresh mortars, Cement and Concrete Research 70 (2015) 50-59.

(36) Canadian Standard Association, CSA A3000-13, Cementitious Materials Compendium, Canadian Standard Association, Mississauga, Calif., 2013.

(37) ASTM International, ASTM C1012, Standard Test Method for Length Change of Hydraulic-Cement Mortars Exposed to a Sulphate Solution, ASTM International, West Conshohocken, USA, 2015.

(38) ASTM International, ASTM C114, Standard Test Methods for Chemical Analysis of Hydraulic Cement, ASTM International, West Conshohocken, USA, 2015.

(39) T. Saito, A. Isogai, TEMPO-mediated oxidation of native cellulose. The effect of oxidation conditions on chemical and crystal structures of the water-insoluble fractions, Biomacromolecules 5.5 (2004) 1983-1989.

(40) Y. Qing, R. Sabo, J. Y. Zhu, U. Agarwal, Z. Cai, Y. Wu, A comparative study of cellulose nanofibrils disintegrated via multiple processing approaches, Carbohydrate polymers 97.1 (2013) 226-234.

(41) L. Segal, J. J. Creely, A. E. Martin, C. M. Conrad, An empirical method for estimating the degree of crystallinity of native cellulose using the x-ray diffractometer, Textile Research Journal 29 (1962) 786-794.

(42) ASTM International, ASTM C33, Standard Specification for Concrete Aggregates, ASTM International, West Conshohocken, USA, 2016.

(43) ASTM International, ASTM C128, Standard Test Methods for Relative Density (Specific Gravity) and Absorption of Fine Aggregate, ASTM International, West Conshohocken, USA, 2105.

(44) ASTM International, ASTM C29, Standard Test Methods for Bulk Density (“Unit Weight”) and Voids in Aggregate, ASTM International, West Conshohocken, Pa., USA, 2016.

(45) ASTM International, ASTM C109, Standard Test Method for Compressive Strength of Hydraulic Cement, ASTM International, West Conshohocken, USA, 2016.

(46) ASTM International, ASTM C1437, Standard Test Method for Flow of Hydraulic Cement Mortar, ASTM International, West Conshohocken, USA, 2015.

(47) ASTM International, ASTM C_{490,} Standard Practice for Use of Apparatus for the Determination of Length Change of Hardened Cement Paste, Mortar, and Concrete, ASTM International, West Conshohocken, USA, 2011.

(48) T. Saito, Y. Nishiyama, J. L. Putaux, M. Vignon, A. Isogai, Homogeneous suspensions of individualized microfibrils from TEMPO-catalyzed oxidation of native cellulose, Biomacromolecules 7.6 (2006) 1687-1691.

(49) N. Banthia, R. Gupta, Influence of polypropylene fiber geometry on plastic shrinkage cracking in concrete, Cement and Concrete Research 36.7 (2006) 1263-1267.

(50) A. M. Brandt, Fiber reinforced cement-based (FRC) composites after over 40 years of development in building and civil engineering, Composite structures 86.1 (2008) 3-9.

(51) V Ramakrishnan, R. Zellers, A. K., Patnaik, Plastic shrinkage reduction potential of a new high tenacity monofilament polypropylene fiber, Special Publication 243 (2007) 49-62.

(52) S. Y. Choi, J. S. Park, W. T. Jung, A study on the shrinkage control of fiber reinforced concrete pavement, Procedia Engineering 14 (2011) 2815-2822.

(53) B. J. Mohr, K. L. Hood, K. E. Kurtis, Mitigation of alkali-silica expansion in pulp fiber-mortar composites, Cement and Concrete Composites 31.9 (2009) 677-681.

(54) S. Iwamoto, W. Kai, A. Isogai, T. Iwata, Elastic modulus of single cellulose microfibrils from tunicate measured by atomic force microscopy, Biomacromolecules 10 (2009) 2571-2576.

(55) N. Bhalerao, S. Wayal, P. G. Patil, A. K. Bharimalla, A review on effect of nano cellulose on concrete, International Journal of Civil and Structural Engineering Research 3.1 (2015) 251-254.

(56) S. J. Peters, Fracture Toughness Investigations of Micro And Nano Cellulose Fiber Reinforced Ultra-High Performance Concrete, Doctoral dissertation, University of Maine, Orono, USA, 2009.

1. A cementitious inorganic material comprising:
an inorganic cured matrix;
a plurality of cellulosic nanofibers embedded in said inorganic cured matrix;
an agent for dispersing said cellulosic nanofibers in said inorganic cured matrix; and
an aggregate dispersed throughout said inorganic cured matrix.

2. The cementitious inorganic material of claim 1 wherein said plurality of cellulosic nanofibers are sourced from any of: wood-based and natural plant based biomass, algae, bacteria, and tunicates, sisal, flax, hemp, grass, sorghum, barley, sugar cane, sugar beet pulp, pineapple leaf fibers, banana rachis, soy hulls, kenaf stem, swede root, wheat straw, carrots, ramie, empty fruit bunches, palm trees, potato pulp, branch bark of mulberry, bagasse, rice straw, grape skins, stems of cacti, coconut husk, bamboo, pea hull fiber, cotton and industrial bioresidues, or a combination thereof.

3. The cementitious inorganic material of claim 1 wherein said plurality of cellulosic nanofibers further comprise retained water.

4. The cementitious inorganic material of claim 1 wherein said plurality of cellulosic nanofibers are: cellulose, methylated cellulose, carboxylated cellulose, aminated cellulose, cellulosic nanocrystals, or a combination thereof.

5. The cementitious inorganic material of claim 1 wherein said plurality of cellulosic nanofibers are present in an amount that exceeds a percolation threshold of said inorganic cured matrix

6. The cementitious inorganic material of claim 1 wherein said plurality of cellulosic nanofibers include reactive groups that react with said inorganic matrix as it cures.

7. The cementitious inorganic material of claim 1 wherein said plurality of cellulosic nanofibers are elongated.

8. The cementitious inorganic material of claim 1 wherein said plurality of cellulosic nanofibers each have a diameter of 0.1 to 100 nm.

9. The cementitious inorganic material of claim 1 wherein said plurality of cellulosic nanofibers each have a length of 0.01 to 5000 μm.

10. The cementitious inorganic material of claim 1 wherein at least one of said plurality of cellulosic nanofibers has bonded thereto a plurality of moieties of cationic group, anionic group, Zwitterion group, C₁-C₄ alkyl , synthetic polymers of from 3 to 5,000 repeat units, hydroxyl, C₁-C₄ alkyl ether, carboxyl, C₁-C₄ alkyl ester, thiol, sulfonic acid, sulfinic acid, phosphate, phosphonic acid, nitrate, aminonium, aldehyde, ester, azide, nitro, amide, imine, imide, nitrile, isocyanate, peptide, primary amino, C₁-C₄ alkyl amino, or combinations thereof.

11. The cementitious inorganic material of claim 1 wherein said aggregate is one of: sand or gravel sourced from igneous, metamorphic or sedimentary rocks, manufactured sand, or a combination thereof.

12. The cementitious inorganic material of claim 1 wherein said aggregate is quartz sand.

13. The cementitious inorganic material of claim 1 wherein said inorganic cured matrix is one of: non-hydraulic or hydraulic cement, Portland cement, gypsum, plaster of Paris, lime-based systems, calcium aluminate cement, phosphate cement, alkali-activated materials, geopolymers, mineral admixtures and masonry cements, other calcareous binders, silty-clayey soils, or a combination thereof.

14. A process of making the cementitious inorganic material of claim 1 comprising:
blending the cellulosic nanofibers with water until a homogenous solution is achieved;
mixing the dispersing agent with the homogenous mixture;
mixing the inorganic matrix material with the homogenous solution;
mixing in the aggregate; and
allowing the mixture to cure.

15. The process of claim 14 wherein blending includes applying a shear rate of 100 to 10,000 per reciprocal second.
